(19) United States
(12) Patent Application Publication
(10) Pub. No.: US 2001/0054245 A1
(43) Pub. Date: Dec. 27, 2001

(54) Holding for hunting and fishing licenses, transport tags, species catch records, permits, stamps, and the like

(76) Inventor: Brad L. Williams, Bellingham, WA (US)

Correspondence Address: Mr. Brad L. Williams, 2305 Crestline Drive, Bellingham, WA, 98226, US

(21) Appl. No.: 09/747,235

(22) Filed: Dec. 26, 2000

Related U.S. Application Data
(60) Provisional application No. 60/173,130, filed on Dec. 27, 1999.

(51) Int. Cl. G09F 3/18

(52) U.S. Cl. 40/661

(57) ABSTRACT

A holder for specific sized, state-issued hunting and fishing, transport tags, species catch records, and the like is provided, which consists of a specifically sized structure of minimum thickness and maximum capacity to accommodate multiple required documents, said holder is for protecting the items in water-resistant containment devices while allowing the viewing and/or display of the items thereof. A fastener is for securing the structure in a folder manner to be worn on one's person in either a colorful, decorative fabric (opaque) side out, or in a clear (transparent), see-through (reversible) side out, said holder to be worn or carried in a regular shirt or pants pocket, or on one's belt or on a lanyard as to be worn around one's neck. Lanyard, an optional feature.

### BACKGROUND OF THE INVENTION

1. Field of the Invention

The instant invention relates generally to sign devices and more specifically it relates to a storage and/or display holder for specific sized, state-issued hunting and fishing licenses, transport tags, and species catch records and the like. More particularly, to a new and improved holder for specific sized, state-issued hunting and fishing licenses, transport tags and species catch records and the like which is adapted to be worn on one's person in a regular sized shirt or pants pocket or in a regular or reversible holder position on one's belt or around the neck via a lanyard (optional feature) for display and/or viewing purposes on contents thereof.

The present invention concerns a new and improved novel holder that is highly efficient and easy to use, store, and display hunting and fishing licenses, transport tags, and species catch records and the like, and has particular reference to a holder adapted for specifically-sized, state issued hunting and fishing licenses, transport tags, and species catch records mandatory for one's right or license to hunt or fish. The holder has particular reference to a double pocket-type holder adapted to holding and/or displaying hunting and fishing licenses, transport tags, and species catch records and the like that are inserted within the two pockets. The invention further relates to a device for alternately displaying and storing one of a plurality of interchangeable licenses, tags, or species catch records, and the like.

The present invention is related to a device for displaying and storing data such as that evidencing the existence of a license in force, the quality of a member with a contract of commutation in connection with hunting, fishing, or other like indications.

2. Description of the Prior Art

Since the inception of the state-issued, mandatory licenses for the skilled hunter and fisherman, it has long been a desire of said participants to have a holder to store, display and utilize for these numerous varieties of licenses, transport tags, species catch records, and the like in association with hunting or fishing. Different holders have generally been utilized to display and store one or two of these important papers and the like. Since the states have been issuing hunting and fishing licenses, transport tags, species catch records, and the like, there has not been a simplified holder known to fit the specifically-sized paperwork required to be carried on one's person while engaged in the act of hunting or fishing, or has there been simply a holder for the use of storing and carrying this bulk of printed matter at any time. Some states require as many as twenty-some documents to be carried on or about one's person. State and federal laws require commercial fishermen, tender services and fish buyers to display one's licenses in a holder on a lanyard around one's neck for long distance viewing by state and federal enforcement officials.

In years past, many types of holders were intended for client/customer/consumer use and often furnished by store proprietors. The holders were used by proprietors or license vendors and given to consumers, and were intended to provide adequate storage and display properties within the holders. One would simply “stuff” (put) the newly purchased licenses, tags, and catch records and any other supplied and purchased paperwork into the containment holder device that was offered despite its usual shortcoming of being too small and under-sized and designed to be housed within another wallet. Holders have yet to be developed and manufactured that provide a person with the ability to house more than one or two specific-sized licenses, tags, or catch records in a holder in which they fit appropriately, either for storage, or for being worn on one's person in a display fashion. Nor have they been adequate to store today's increasing amount of paperwork in the appropriate display fashion that is many times required by state and federal laws for different user groups.

These types of holders perform a very limited function when the licenses, tags, and catch records for hunting of all types and fishing in all waters do not fit, especially for the hunters or fishermen who do several hunting or fishing sports and are required to have a license for each one. These rather generic, individual store generated holders perform a very limited function and do not provide for storing of multiple informational paperwork and the displaying of this increasing amount of printed material which also may need to be easily read by other persons.

It has long been a desire of hunters and fishermen to have an adequately designed and manufactured holder for housing, storing and displaying numerous specifically-sized licenses, transport tags, catch records and the like. One such device as illustrated by U.S. Pat. No. 03,829,995 is a license holder adapted to be worn on the attire of a user by a pin-like device. This device works by allowing in particular one or dual cards to be displayed on one's wearing apparel. While this type of device proves useful for the specific purpose of displaying one or two cards, it does not provide an effective method of displaying all the required, state-issued, multiple licenses, transport tags, and catch records which have proven over time to now be much larger, bulkier, and extensive in their printed form.

While this type of device may have become popular as a “fad” method of displaying dual cards, it has brought with it the desire to have a regular type holder that fits in one's pockets or can alternately also be worn on one's person, such as attached in either an outside (opaque) or inside (transparent) position on a belt, or on a lanyard. In addition, this device most notably is limited to dual cards and not multiple licenses and/or copies of required/mandatory paperwork as required by many states.

There has unquestionably existed for some time different holders into which licenses, transport tags, and species catch records may be inserted and removed and even displayed. However, there has yet to be a holder which is inexpensive and readily adaptable to such purpose to a sufficient degree to obtain general public acceptance. What is desired then, is a holder having a sufficient structural integrity, made of water proof material, which can hold and/or display multiple licenses, transport tags, and species catch records, is reversible, and can be worn on one's person, or in the usual normal place of one's shirt or pant pocket, or on a lanyard around one's neck, and be of adequate size to fit specifically-sized, state-issued hunting and fishing licenses, transport tags, species catch records, and the like.

Still another disadvantage of these prior art holders is that many of them do not provide an inexpensive means of providing a large enough, and specifically-sized holder for each state's mandatory hunting and fishing licensing, transport tags and species catch record sheet assignments. A desirable holder would be one sufficient to hold the appropriate state-required paperwork with the key being a holder of a specific size to accommodate each state's desired paperwork generated by manual or machine automated systems of licensing and the like.

Innovations for holders and the like have been provided in the prior art that are described as follows. Even though these innovations may be suitable for the specific individual purposes to which they address, they differ from the present invention as hereinafter contrasted.

U.S. Pat. No. 3,829,995: License Holder by inventor Richard Fakoury

A card holder adapted to be worn on the attire by a user generally consisting of a base ply, an upper front ply having a window, secured to an upper front portion of the base ply to provide an upwardly opening, first card receiving pocket and a depending flap on the base ply, a lower front ply secured at an upper portion thereof to a front side of the base ply depending flap, a lower ply secured to the lower front ply to provide an upwardly opening, second card receiving pocket, means for detachably securing the lower front and back plies to a portion of the upper front ply when the lower and back plies are folded rearwardly and upwardly, along the rear side of the base ply, and means for detachably securing the holder to the attire of a user

U.S. Pat. No.: D 366,146: Combined hunting license holder with pen by inventor Robert V. Bertrand.

The ornamental design for a combined hunting license holder with a pen.

U.S. Pat. No.: D 413,326: Hunter's removable cap cover with license holder attachment by inventor Johnathan R. Lape.

The ornamental design for a hunter's removable cap cover with license holder attachment.

U.S. Pat. No.: 5,502,912: Display Holder for a Picture, Certificate, License Inspection Sticker, Registration Sticker and the Like by inventor Andrew LeBoff.

A display holder for a registration sticker, inspection sticker, certificate, license, and photograph and the like is provided, which consists of a structure for protecting the display item while allowing viewing thereof. A fastener is for securing the protecting structure to a flat surface, so that a person can view the display item therefrom.

U.S. Pat. No. 4,184,276: Motor Vehicle Registration Card Holder by inventor Albert Hernandez.

A U-shaped holder made of a light flexible material having grooves in the inside walls and bottom thereof forming a slot to receive an automobile registration card or plate. Affixed to one face of the holder is a layer of flexible material coated with a pressure sensitive adhesive to facilitate securing the holder to the windshield of an automobile.

U.S. Pat. No. 5,025,581: Display Holder by inventor Ellen C. Polzin.

A photograph display holder is provided in which a cover with a transparent area for viewing a photograph is temporarily attached to a surface by an adhesive coating made of an impermanent adhesive material affixed to one side of the cover. A containing structure holds a photograph behind the transparent area of the cover while the cover is attached to a surface. An insertion opening allows a photograph to be removed and replaced with another photograph without removing the cover from the surface to which the cover is attached. The adhesive coating is covered by a removable layer of material. The cover is made of a pliable material. A transparent layer covers the transparent area in the cover. A protective layer of material with an adhesive coating made of an impermanent adhesive material affixed to one side of the protective layer is temporarily attached to the transparent layer. The transparent layer being made of a pliable transparent material. The cover is die cut along its outer edges and has ornamental designs placed on it.

U.S. Pat. No. 4,955,153: Display Sign Holder and Display Sign Therefore by inventors Leonard N. Albrecht and Steven R. Burke.

Disclosed is a display sign holder in the form of a semi-rigid rectangular sheet of optically clear plastic having elongated flat spacing structures extending along its top and bottom margin areas on one side so as to space the plastic sheet from a supporting surface and guide the longitudinal insertion and removal of an elongated display sign there between. The spacing structures are flat strips printed with ink on one or both sides to permanently display marginal information or design, and relatively thin transparent adhesive layers are disposed on both sides of the strips to adhere them to the plastic sheet and to the supporting surface.

U.S. Pat No. 4,827,646: Vehicle Sign Display Device by inventors Bradley J. Miller and Paul McKenna.

A sign display device for use in vehicles such as automobiles comprising a variable height sign holder extendably mounted on a housing or frame which has an attachment means for holding the display device on a vehicle door or similar structure. The variable height sign holder is a manually extendible structure preferably comprising a series of pairs of lever arms pivotally fastened together in the center on the ends to adjacent pairs so as to form a scissors action structure. An actuation handle is mounted on one end of the pairs of lever arms to move the ends closer together and extend the sign holder. A sign or card holder frame is positioned on an upper end of the pairs of lever arms for holding the signs to be displayed by, or stored in, the display device.

U.S. Pat. No. 4,695,077: Automobile Insurance Card by inventor Roger Pretre.

A label showing insurance data or the like having a transparent film attached thereto by a first adhesive layer between the label and the film, and a second adhesive layer on the opposite side of the film for attaching the combined label and film to the inner surface of a glass pane of an automotive vehicle.

Numerous innovations for holders for a picture, certificate, license and the like have been provided in the prior art that are adapted to be used. Even though these innovations may be suitable for the specific individual purposes to which they address, they would not be suitable for the purposes of the present invention as heretofore described.

### SUMMARY OF THE INVENTION

A primary object of the present invention is to provide a holder for hunting and fishing licenses, transport tags, and species catch records and the like that will overcome the shortcomings of the prior art devices.

Another object is to provide a holder for hunting and fishing licenses, transport tags, and species catch records that will protect, allow viewing, and secure and store the licenses, tags, and catch records and the like with a Velcro (Trademark) closure.

An additional object is to provide a holder for hunting and fishing licenses, transport tags, and species catch records that is simple, easy to use, and will be a usual-type holder that fits in one's shirt or pants pocket or on one's person such as on a belt or on a lanyard as can be worn around one's neck either in the opaque side out or the transparent (reversible) side out. Lanyard feature is optional.

A further object is to provide a holder for hunting and fishing licenses, transport tags, and species catch records and the like that is economical in cost to the manufacturer and could replace the inadequately sized holders available in today's market. This holder is designed to be a system within itself.

Still another object is to provide a holder for hunting and fishing licenses, transport tags, and species catch records and the like that will allow a store proprietor/state license vendor an inexpensive means of supplying the customers with a holder that can also be used for advertising purpose should a logo be desired on the holder with pertinent information pertaining to the vendor.

Vendors of state-issued licenses, transport tags, and species catch records, and other required/mandatory paperwork and the like, are identified by each individual state. Although this serves to advertise the vendor, my holder with the logo and other information on it about the specific vendor/store will highlight the proprietor's desire to advertise his establishment and if given to the customer, will be an incentive for advertising and marketing purposes. It is therefore an object of this invention for the use of a logo and/or other information and the like to be put on the holder when requested by the vendor/store proprietor and/or by an individual user making it personalized for said individual(s).

Another object is for the holder to be designed of colorful, durable and water resistant fabric that can also be silk-screened with identification, animal art or an outdoor sports motif to provide an attractive holder suitable for ownership that provides something different from the old style holders made of only plastic, and not usually of sufficient size to accommodate said information, decoration and/or utilitarian purposes. These holders are designed to be added to one's existing storage system such as a wallet or purse, or the like.

It is the object of the present invention, accordingly, to provide a compact, inexpensive, and convenient device for storing and/or displaying in transparent, see through pockets the entire bulk of state required paperwork for use by hunters and fishermen.

Another object of the invention is to provide a new and improved license holder that is light in weight, water-resistant, and easy and inexpensive to manufacture by means of industrial sewing methods and machinery, and can also be reversed to display paperwork, or folded as such to conceal (secure) and/or display the paperwork providing adaptability of the holder to the user's needs.

These and other objects of the invention are attained by providing a holder composed of sturdy, but lightweight and flexible, water resistant (both opaque and transparent), colorful material that can be printed, stitched, silk screened and the like with any desired application and suitable for containment of numerous copies and varieties of hunting and fishing licenses, transport tags, and species catch records and the like and can be worn on one's person, either in a regular shirt or pants pocket or in a regular closed (opaque) position or in a displaying (transparent) position on one's body such as a on belt, or around the neck as by a lanyard, an optional feature of the holder.

### BRIEF DESCRIPTION OF THE DRAWINGS

Other objects and advantages of the invention will become more apparent to those persons having ordinary skill in the art to which the present invention pertains from the following description taken in conjunction with the accompanying drawings in which:

FIG. 1 is the two transparent pocket side of the holder when in the open, flat position showing the loop of the Velcro (Trademark) fastener. Holes or eyelets are shown below the loop fastener and at each side to provide for the installation of a lanyard, if this feature is desired. Sewn binder tape is shown that holds this transparent pocket side to the opaque, waterproof fabric side.

FIG. 2 is the opaque, waterproof fabric side of the holder when in the open, flat position showing the hook side of the Velcro (Trademark) fastener and the area where an animal, art, outdoor sports motif, and the like can be printed, stitched, silk-screened and the like there upon. Positioning of eyelets are shown. Binder tape and lock stitching shown that holds transparent pocket side and water-proof fabric sides of holder together.

FIG. 3 is the opaque, water-proof, protective fabric side of the holder when in the folded position showing the fastener on the visible side of the holder as viewed towards the viewer. Eyelets are shown for lanyard attachment, when desired.

FIG. 4 is the opaque, water-proof, protective fabric side of the holder when in the folded position showing one possible printed, stitched, silk-screened and the like side and not showing the Velcro (Trademark) fastener in view of the viewer, or showing it on the back or away side.

FIG. 5 is the two transparent pocket side of the holder when in the folded (reversed) position allowing for the display of contents where within.

FIG. 6 is the holder in the reversed, folded position (transparent pocket side out) showing the capability of wearing it on one's belt thereby displaying the contents of the pocket for viewing by one's self or another person.

### LIST OF REFERENCE NUMERALS UTILIZED IN THE DRAWINGS

8—Holder

9—Display compartment, transparent, clear, see-through pocket 1

10—Display compartment, transparent, clear, see-through pocket 2

11—Velcro (Trademark) fastener: hook side

12—Velcro (Trademark) fastener: loop side

13—Fold at stitched center seam

14—Stitched center of holder showing dual bottom of display compartments

15—Opaque, waterproof, protective fabric side of holder

16—Opaque, waterproof, protective fabric side of holder showing stitched fabric tape around all outer edges

17—Display side of holder having two display compartments/pockets in the reversible position

18—Printed, stitched, silk-screened and the like fabric side of holder

19—Top of open display compartment/pocket 1

20—Top of open display compartment/pocket 2

21—Velcro (Trademark) fastener: closed position, viewing it from opaque, waterproof, protective fabric side as it faces toward the viewer

22—Velcro (Trademark) fastener: closed position, viewing it from the opaque, waterproof, protective fabric side as it faces away from the viewer

23—Eyelet holes for lanyard, an optional feature

24—Belt, as may be worn on one's person

25—Lanyard, an optional feature, as may be strung through eyelets

26—Nylon thread, lock stitching

The novel features which are considered characteristic for the invention are set forth in the claims. The invention itself, however, both in its construction and method of operation, together with additional objects and advantages thereof, will be best understood from the following description of the specific embodiments when read and understood in connection with the accompanying drawings.

### DETAILED DESCRIPTION OF THE PREFERRED EMBODIMENT

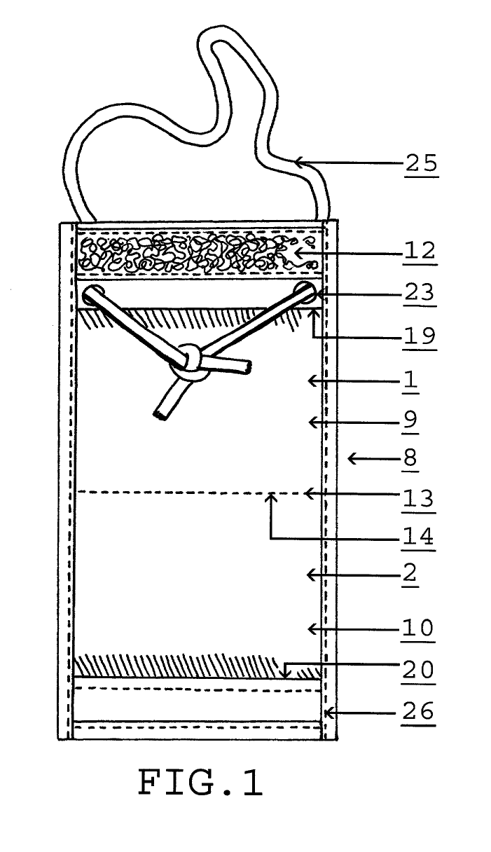

Referring to FIG. 1 which is a view of the holder 8 showing the two transparent, clear, see-through pockets 1 and 2 made of one sheet of material, with the holder 8 in a flat, open position showing the loop side 12 of the Velcro (Trademark) fastener, the holder having dual compartment/pockets 1 and 2 to display hunting and fishing licenses, transport tags, species catch records and the like within. Each pocket open at the top 19 and 20 and stitched at the mid-point/center 14 to indicate the bottom of both pockets 1 and 2 and can be used as a guide when folding 13 the holder. Eyelet holes 23 for lanyard 25 (the optional features) are shown placed at each side of holder 8 and below Velcro (Trademark) fastener, loop side 12.

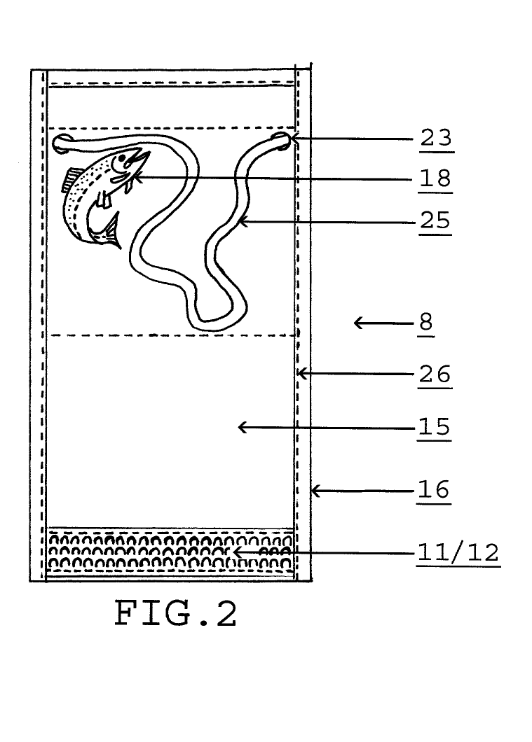

Referring now to FIG. 2 which is a view of the holder 8 showing the opaque, water-proof, protective fabric side 15 with the holder 8 in a flat open position showing the hook side 11 of the Velcro (Trademark) fastener stitched to the fabric at one end. This fabric side 15 of holder 8 is the printed, stitched, silk-screened and the like side 18. A further feature of this holder 8 is the binding tape 16 sewn around all outer edges securing both pieces of fabric together, to include the transparent, clear, see-through pockets 1 and 2 made of one sheet of material and the opaque, water-proof, protective fabric 15, and said tape 16 securing the top and bottom or shorter sides of the opaque, water-proof, protective fabric 15 together with the Velcro (Trademark) fastener material 11 and 12 by means of sewing machine lock stitched with heavy duty nylon thread 26. Eyelet holes 23 for lanyard 25 are shown placed at each side of holder 8 and below Velcro (Trademark) fastener, hook side 11. Eyelets 23 and lanyard 25, an optional feature.

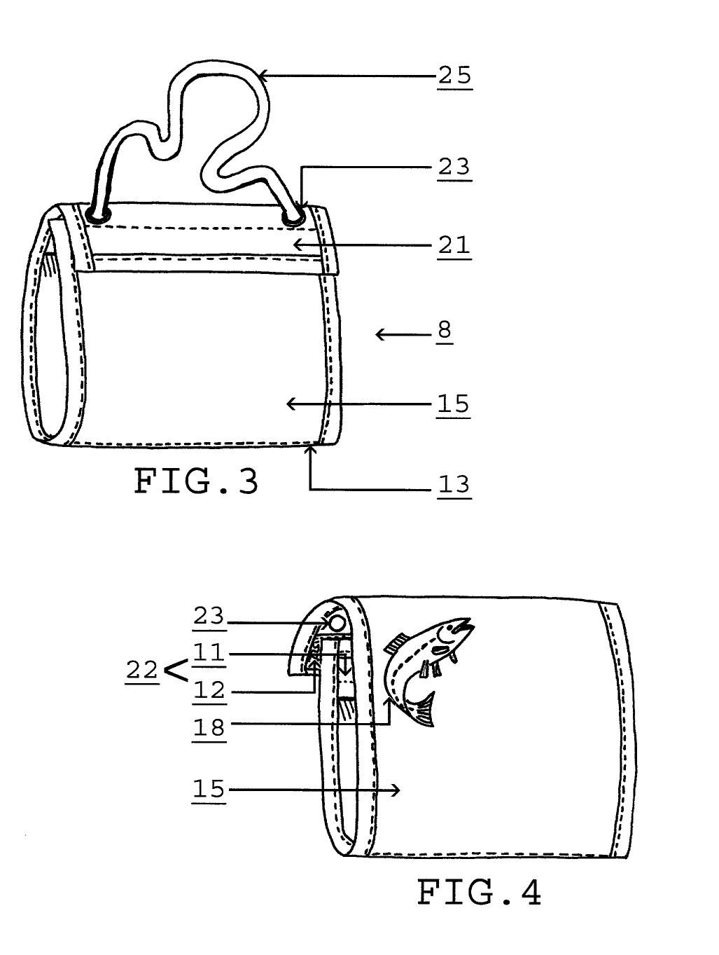

Referring next to FIG. 3 which is the folded 13 position of holder 8 showing the opaque, water-proof, protective fabric side 15 and the Velcro (Trademark) fastener in a closed position 21 as it is viewed toward or facing the viewer. Eyelet holes 23 for lanyard 25 visible now as appearing at top of Velcro (Trademark) fastener when in the closed position 21.

Referring further to FIG. 4 which is the folded opaque, water-proof, protective fabric side 15 of the holder 8 when the Velcro (Trademark) fastener 11 and 12 is not shown facing the viewer or shown away from the viewer 22, showing the printed, stitched, silk-screened or the like fabric area 18 suitable for possible animal art or an outdoor sports motif or the like as may be applied as per various methods previously described or as may be ingeniously created. One eyelet 23 for lanyard is visible.

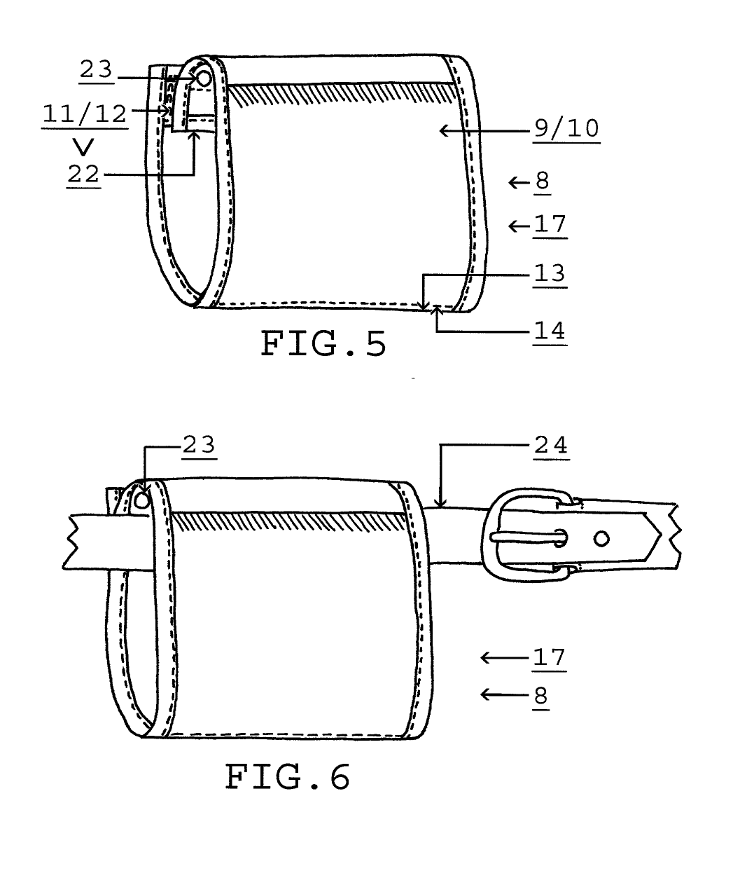

Referring next to FIG. 5 which is the display compartment, transparent, clear, see-through pocket side 9 of the holder 8 when it is in the folded (reversible) position 17 showing the Velcro (Trademark) fastener 11 and 12 closed and facing away from the viewer 22 with only one transparent, clear, see-through pocket 1 and/or 2 visible to the viewer. Of special note is the stitched center seam 14 of holder 8 showing the dual bottom of both transparent, clear, see-through pockets 1 and 2 and the point at which the user will fold 13 holder 8 at this stitched center 14 or dual bottoms of pockets 1 and 2. One eyelet 23 for lanyard is visible. Both eyelet and lanyard, an optional feature.

Referring lastly to FIG. 6 which is the holder 8 shown in the folded, reversible position 17 with the holder 8 fastened over a belt 24 to be worn on one's person if so desired. Eyelet 23 visible, optional feature.

It will be understood that each of the elements described above, or two or more together, may also find a useful application in other types of constructions differing from the type described above.

While the invention has been illustrated and described as embodied in a holder, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by a patent in which an exclusive property or privilege is claimed is set forth in the following claims:

1. A holder comprising;
a) at least two separate, dimensioned, and inner compartments or pockets to hold and/or display hunting and fishing licenses, transport tags, and species catch records and the like, said compartments being open at opposing ends functioning to facilitate the addition and removal of display items, said compartments being manufactured from transparent, clear, see through material.
b) a covering fabric commensurate with, and joined to said inner sheet by binder tape with a sewing machine using the lock stitch, said covering being made of a water-proof, colorful fabric, said fabric to perform as an opaque, outer protection for the inner two separate, dimensioned compartments/pockets, said fabric to be functionally suitable for printing, stitching, silk-screening and the like of the fabric for art, identification, advertising, personalized, and the like purposes.
c) seamed, taped, and sewn edges, said edges constituting the sturdy, and lightweight and flexible border to hold the inner material and covering fabric together, said binder tape border to be lock stitched by industrial sewing methods.
d) a fastener of Velcro (Trademark), said fastener to provide for the holder to be folded into a compact shirt or pants pocket sized holder, such that the contents can be secured within.
e) two eyelet holes (optional feature) punched through covering fabric, said eyelet holes to provide for a lanyard (optional feature) which can be used to display the holder which can be worn around one's person, such as the neck, when this is desired or required by law.

2. A holder as described in claim 1, whereas said holder having a fastening mean therein to securely fasten the holder in a folded position allowing it to house the paperwork, but also fit in a regular-sized shirt or pants pocket, as a system within itself for the housing of all the required state-issued hunting and fishing paperwork.

3. A holder as described in claim 1, whereas said holder's dimensional compartments or pockets are transparent in their makeup providing for see through, visual display of the contents.

4. A holder as described in claim 1, whereas said holder material is both opaque and transparent and waterproof in its makeup.

5. A holder as described in claim 1, whereas said holder can be folded in either direction, opaque or transparent side out, thereby making it reversible and capable of display properties with pocket openings opposed so when in the reverse position, the openings point upwards and objects within will not fall out, and being held in a closed position by a Velcro fastener.

6. A holder as described in claim 1, whereas said holder can be printed, stitched, silk-screened and the like for any purpose, such as decorative art and the like, or for advertising purposes by the vendor/store proprietor, and/or for user personalized and identification purposes and the like.

7. A holder as described in claim 1, whereas said holder has eyelets for the purpose of providing it with a lanyard, making it wearable around one's neck, an optional feature of said holder, fulfilling regulatory, state and/or federal laws that require commercial fishermen, tender services, fish buyers and the like to display licensing in a holder on a lanyard around one's neck for long distance identification and viewing by officials.

8. A holder as described in claim 1, whereas said holder in the folded position opaque or transparent side out, secured by the Velcro (Trademark) fastener can be placed on one's belt for carrying or storage of said holder on one's person.

9. A holder as described in claim 1, whereas said holder can be worn about one's person such as the neck, when said holder has a lanyard attached to it, an optional feature, said lanyard to be held in place by stringing it through eyelets, an optional feature.
